(19) United States
(12) Patent Application Publication
(10) Pub. No.: US 2015/0290712 A1
(43) Pub. Date: Oct. 15, 2015

(54) METHOD AND DEVICE FOR IMPROVING MATERIAL QUALITY IN GENERATIVE MANUFACTURING METHODS

(71) Applicant: MTU Aero Engines AG, Munich (DE)

(72) Inventors: Joachim Bamberg, Dachau (DE); Roland Hessert, Herrsching (DE); Benjamin Henkel, Munchen (DE)

(21) Appl. No.: 14/679,538

(22) Filed: Apr. 6, 2015

(30) Foreign Application Priority Data
Apr. 11, 2014 (DE) 10 2014 207 001.5

(51) Int. Cl. B22F 3/105; B28B 1/00; B29C 67/00

(52) U.S. Cl. CPC B22F 3/1055; B29C 67/0077; B28B 1/001; B29C 67/0085; B22F 2003/1056; B29K 2105/251

(57) ABSTRACT

The present invention relates to a method and a device for material processing with a high-energy beam (7), with a beam-generating device (4) for generating a high-energy beam and with a component holder (2), in which is disposed the material that is to be processed with the high-energy beam, wherein the beam-generating device and the component holder are disposed or can be disposed relative to one another so that the high-energy beam impinges on the material surface (12) of the material to be processed at an angle not equal to 0° or 180° or a whole-number multiple thereof, and wherein the beam-generating device or at least parts thereof and/or another beam-generating device can be disposed, and/or that the beam-generating device comprises a deflection means (5, 6), so that a high-energy beam (7a) can be aligned parallel to and at a distance from the material surface (12) to be processed.

### BACKGROUND OF THE INVENTION

1. Field of the Invention

The present invention relates to a method and a device for the material processing or layerwise manufacturing of objects, in particular, a method and a device for selective laser-beam or electron-beam melting or sintering.

2. Prior Art

Generative manufacturing methods for the production of a component, such as, for example, selective laser melting, selective laser sintering, or laser deposition welding, in which the component is built up layerwise with the use of powder material, are employed in industry for so-called rapid tooling, rapid prototyping, or also for the production of mass-produced products within the scope of rapid manufacturing. For example, based on the material employed, such methods can be used also particularly for the production of turbine parts, especially of parts for aircraft engines, in which these types of generative manufacturing methods are advantageous. An example of this is found in DE 10 2010 050 531 A1.

In the case of generative manufacturing with a layerwise introduction of material, however, the method can lead to the formation of material agglomerations, such as, for example, to the formation of welding beads that protrude from the layer which is introduced and these agglomerations can reach dimensions that may present problems in the subsequent production of another layer. Therefore, on the one hand, the introduction of the subsequent powder layer can be disrupted, and the material agglomerations formed from the previous step can also cause bonding defects when the powder is bonded in the layer, so that the material of the finished component contains defects. This may lead to the breakdown or failure of the component during its later application, which must be correspondingly avoided.

### BRIEF SUMMARY OF THE INVENTION

### Object of the Invention

Thus, the object of the present invention is to provide a method and a device for the generative manufacture of components or for material processing using high-energy beams, in which the above-described problem of bonding errors will be avoided or at least reduced. At the same time, the method shall be easy to carry out and the device shall be simply constructed and easy to operate, in order to be able to employ the corresponding material processing in industrial processes.

### Technical Solution

This object is achieved by a device with the features of the present invention as set forth in the claims.

In order to solve the above-described problem, the invention proposes to eliminate undesired material agglomerations after forming a deposited material layer, or at least to reduce these agglomerations to a non-critical size, so that the subsequent processing steps for introducing further layers are not adversely affected. For this purpose, the invention proposes to guide a high-energy beam over the processed surface parallel to and at a distance from this surface after a processing step in which a layer has been deposited, for example, by melting or sintering of powder particles, in order to eliminate or level out possibly present material agglomerations. Correspondingly, a device is proposed in which the beam-generating device and the holder for the component can be arranged relative to one another so that not only can a high-energy beam impinge on the material to be processed for the material processing, but also so that the beam can be guided parallel to and at a distance from the processed material surface or the material surface to be processed again in a subsequent step. Correspondingly, the device is equipped so that the high-energy beam can impinge on the material surface of the material to be processed not only at an angle not equal to 0° or 180° or a whole-number multiple thereof, but rather the device is equipped so that a high-energy beam can also be guided parallel to the material surface that is processed or will be processed, thus at an angle of 0° or 180° to the material surface. For this purpose, either the beam-generating device or parts thereof can be designed so that they can be arranged relative to the component holder and thus relative to the material surface to be processed, or an additional beam-generating device can be provided in order to generate another, separate high-energy beam. Moreover, it is also possible to provide a deflection mechanism, with which the high-energy beam used to carry out the material processing can be deflected, so that a parallel guiding of the beam to the processed material surface is possible.

Correspondingly, a processing plane can be defined in the device, in which the high-energy beam for material processing usually impinges on the material to be processed so as to melt or sinter it, whereby in the corresponding invention, the processing plane and/or the beam-generating device(s) is (are) designed such that a high-energy beam can also be guided parallel to and at a distance from the processing plane. The processing plane is therefore understood to be the material surface that is to be processed with the high-energy beam or has already been processed by the high-energy beam.

The component holder may be an uptake for a powder bed, in which powder can be taken up in order to conduct, for example, selective laser melting or selective laser sintering. Correspondingly, the high-energy beam can be a laser beam or it can be an electron beam or another suitable beam with which powder material can be melted or sintered.

If, in order to generate a beam aligned parallel to the material surface or to the processing plane, a deflection mechanism is employed so as to utilize a high-energy beam which is already employed for the material processing also for leveling or eliminating material agglomerations (beam or laser clearing), the deflection mechanism may have at least one deflection mirror that is mounted adjustably in order to enable, by possible adjustments, a sweep of the parallelly guided beam over the entire material surface. The deflection mirror can be designed correspondingly so that it can be tilted in order to be able to adjust different reflection angles, and/or so that it can be rotated in order to enable a sweep of the material surface by rotation of the mirror. Moreover, the mirror can also be mounted adjustable translationally in order to also assure a sweep of the parallelly guided laser beam over the entire material surface by displacement along one or more axes.

Therefore, the laser beam that is guided parallelly over the material surface can cause no damage to surrounding objects nor is it a risk to persons; the device may have a beam absorber, with which the radiation of the high-energy beam is absorbed after sweeping the material surface. In particular, the beam absorber can be provided lying opposite a deflection mechanism and/or at least partially around the component holder.

In addition, the device according to the invention may have a means for characterizing the surface that has been processed and/or is to be processed, in order to be able to determine whether undesired material agglomerations are present, and, if needed, in what form, size, number, distribution, etc. the material agglomerations are present. With the results of the characterization, the parallel guiding of the beam over the material surface then can be controlled correspondingly.

The parallel guiding of the high-energy beam over the material surface can be provided at a distance of less than or equal to 200 μm, in particular less than or equal to 150 μm, preferably less than or equal to 100 μm, in order to be able to eliminate or reduce corresponding material agglomerations that are greater than these named dimensions.

### BRIEF DESCRIPTION OF THE FIGURES

The appended drawings show in a purely schematic way:

FIG. 1 a schematic representation of a device for selective laser melting;

FIG. 2 a representation of the device from FIG. 1 rotated by 90°;

FIG. 3 a flow chart of the method; and

FIG. 4 another flow chart of the method.

### DETAILED DESCRIPTION OF THE INVENTION

Further advantages, characteristics and features of the present invention will be made clear in the following detailed description of an example of embodiment, the invention not being limited to these embodiment examples.

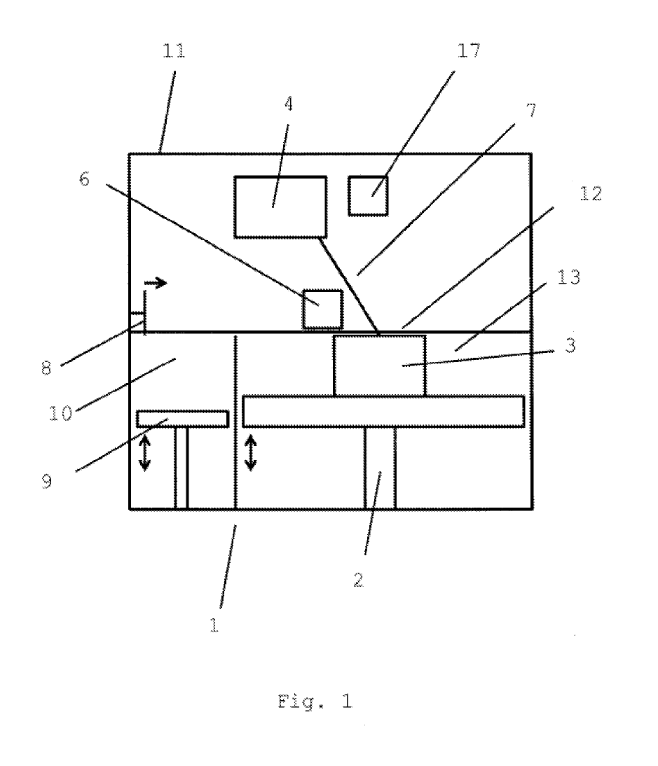

In a purely schematic sectional view, FIG. 1 shows a device 1, as can be used for selective laser melting for the generative manufacture of a component. The device 1 comprises a lift table 2, on the platform of which is disposed a semi-finished product 3, onto which material is deposited layerwise in order to produce a three-dimensional component. For this purpose, powder that is found in a powder supply container 10 above a lift table 9 is moved layerwise by means of the slider 8 over the semi-finished product 3 and subsequently is bonded with the already present semi-finished product 3 by means of the laser beam 7 of a laser 4 by melting and subsequent re-solidifying. The powder material is bonded in one layer with the semi-finished product 3 by the laser beam 7 as a function of the desired contour of the component to be fabricated, the laser beam being moved in a corresponding manner over the powder layer, so that any three-dimensional shapes can be produced. In order to avoid undesired reactions with the surrounding atmosphere during melting or sintering, the process occurs in an enclosed space that is provided by a housing 11 of the device 1, and an inert gas atmosphere is also provided, for example, in order to avoid oxidation of the powder material during deposition, and the like. For example, nitrogen, which is provided via a gas supply source, is used as the inert gas.

Before the powder that is present in the region of the semi-finished product 3 can be melted by the laser beam 7 and bonded with the semi-finished product 3 during re-solidification, the slider 8 produces a powder bed 13 that has a planar material surface 12, which covers the semi-finished product 3, so that a layer of powder material forms between the material surface 12 and the semi-finished product 3, and this layer can be melted by the laser beam 7 and bonded with the semi-finished product 3. The powder material surface 12 correspondingly defines a processing plane, in which the powder material to be processed is melted and bonded to the semi-finished product 3 during the re-solidification. After the material processing, i.e., the deposition of the layer by melting and re-solidifying, the (processed) material surface is formed by the surface of the untreated powder of the powder bed 13 and the surface of the semi-finished product 3.

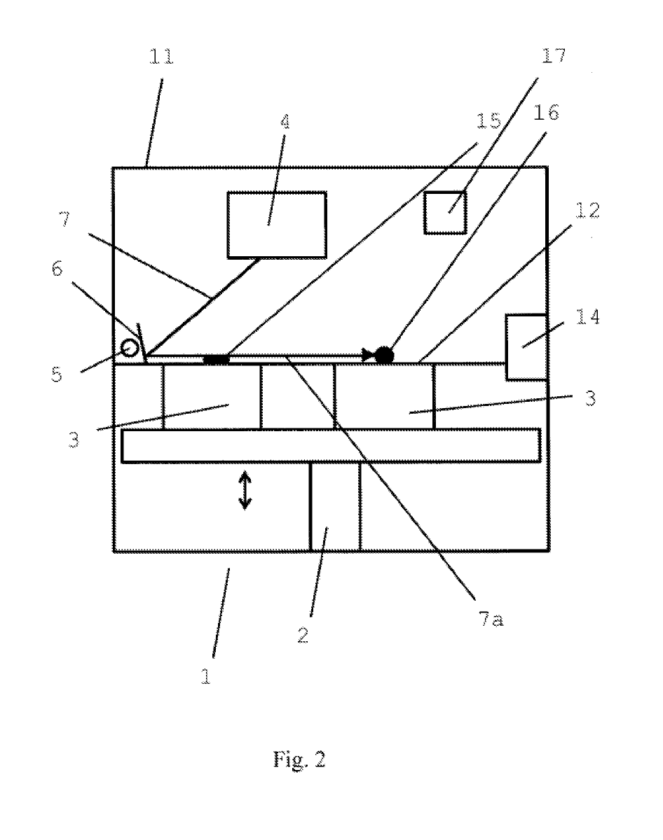

In a sectional view in which the sectional plane has been rotated by 90° when compared to that of FIG. 1, FIG. 2 shows a processing state after the melting of the powder layer and re-solidification of the material has occurred for building up the semi-finished product 3, i.e., the deposition of the layer. It is also recognized in FIG. 2 that several semi-finished products 3 are fabricated simultaneously.

During the formation of the layer, the formation of material agglomerations 16 on the semi-finished products 3 may occur, as is shown outsized on an example for clarification in FIG. 2. Such material agglomerations, which may form as welding beads, disrupt the subsequent layer buildup, since, based on the size of the material agglomeration, it may happen that the powder layer cannot be correctly applied, and/or that the material accumulations are incorrectly melted, so that defects in the form of bonding defects of the material may result in the material of the semi-finished product 3.

According to the invention, this problem is eliminated in that a laser beam 7a is guided parallel to and at a distance from the processed material surface 12, which repeatedly melts and levels off the material agglomerations 16. For this purpose, the laser beam 7 of the laser 4 can be used, this beam having brought about the material processing in the previous method step by selective, layerwise melting of the powder material. The device 1 has for this purpose a deflection mechanism with a mirror 6, which is shown in a front view in FIG. 1 and in a side view in FIG. 2. The mirror 6 is mounted so that it can pivot via an articulation 5, in order to provide the desired reflection angle with which the reflected laser beam 7a can be guided parallel to and at a distance from the material surface 12, as a function of the beaming direction of the laser beam 7.

In addition, the mirror 6 is disposed so that it can rotate around an axis of rotation, which is in the image plane, so that the deflected laser beam 7a can pivot above the material surface 12 of components 3. In this way, material agglomerations 16 can be processed in all regions of the material surface, and, in particular, at different positions in the region of semi-finished products 3. Additionally, the mirror 6 can be moved along an axis that is disposed perpendicular to the image plane of FIG. 2 or runs from left to right in FIG. 1, in order to also make possible in this way a sweep of the deflected laser beam 7a over the entire material surface 12. Based on the beam deflection mechanisms of laser 4, which make it possible that the laser beam 7a can be locked or can be moved above the material surface 12 for the material processing, i.e., for the layerwise melting of the powder, the mirror 6 can also be irradiated with the laser beam 7 correspondingly in its different positions.

In order not to unintentionally focus the laser beam 7a that is guided parallel to the material surface 12 onto any adjacent objects, the device 1 has a laser beam absorber 14, which can extend, for example, along one side of the device 1 lying opposite the mirror 6, thus in the case of FIG. 2, perpendicular to the image plane.

As shown in FIG. 2, the laser beam 7a that is guided parallel to and at a distance from the material surface 12 impinges on a material agglomeration 16, so that the latter is melted by interacting with the laser beam 7a. The material agglomeration 16, e.g., in the shape of a welding bead 16, is leveled off, as shown for the fused lens shape 15. In this leveled-off shape, the material agglomeration 16, now in the shape of a fused lens 15, represents a lesser disruption for introducing the powder layer, and also melting is produced more readily within the powder layer, so that bonding defects in the semi-finished product 3 can be excluded. For this, the distance at which the laser beam 7a is guided parallel to the material surface 12, for example, as a function of the material used, can be adjusted differently in order to eliminate material agglomerations 16 of different sizes. Thus, for example, for a specific material, it may be acceptable, if material agglomerations protrude up to an extent of 200 μm above the processed material surface 12, since in the following layer deposition step, it is assured that such material agglomerations are melted and are bonded reliably with the remaining material. Correspondingly, the distance of the parallel laser beam 7a can also be adjusted to 200 μm, so that the laser beam 7a only impinges on and melts material agglomerations of a larger size perpendicular to the material surface. However, if a material is used, which leads to bonding defects in the subsequent layer deposition process in the case of material agglomerations on the order of magnitude of 100 μm in the direction perpendicular to the processed material surface, the distance of the laser beam 7a guided parallel to the material surface 12 can thus be adjusted to a value of 50 μm.

In order to be able to better adapt the process parameters for the parallel guiding of the beam to the actual situation, for example, with respect to speed of the sweep of the parallel laser beam over the material surface 12, power of the laser beam, etc., a means 17 for characterizing the material surface 12 is provided, with which corresponding material agglomerations 16 can be detected. For example, this means may be an interferometer, with which the order of magnitude of the material agglomerations in the direction perpendicular to the material surface 12 can be determined. If it should be determined with the means 17 for characterizing the material surface that no relevant material agglomerations are present, the process step of parallel guiding of the beam can also be dispensed with.

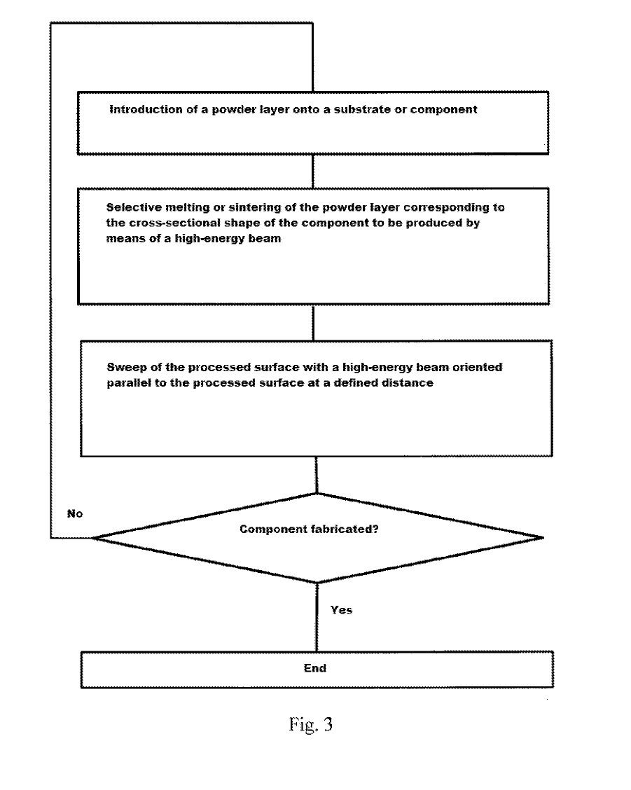

Otherwise, the method for material processing with a high-energy beam or for selective laser melting with the device according to the exemplary embodiment of FIGS. 1 and 2 takes place at least partially according to the flow diagram of FIG. 3.

First, a powder layer is applied onto a substrate or component, such as the semi-finished product 3, for example, by production of a powder bed with a planar material surface 12, as in FIGS. 1 and 2, in which the substrate, component, or semi-finished product 3 is embedded, so that in the region in which the semi-finished product shall be further built up, a powder layer is formed.

In the next step, by selective melting or sintering of the powder layer corresponding to the cross-sectional shape that the component or semi-finished product has in the given layer plane, it is possible to bond the powder material with the semi-finished product 3. For this, the high-energy beam, for example, in the shape of the laser beam of device 1 of FIGS. 1 and 2 will be used.

After the corresponding material processing, a high-energy beam sweeps the processed material surface parallel to and at a distance from the processed surface, in order to level off material agglomerations that have formed in the previous processing step.

If the introduced layer was still not the last layer, then the process is repeated, whereas in the opposite case, the processing is finished.

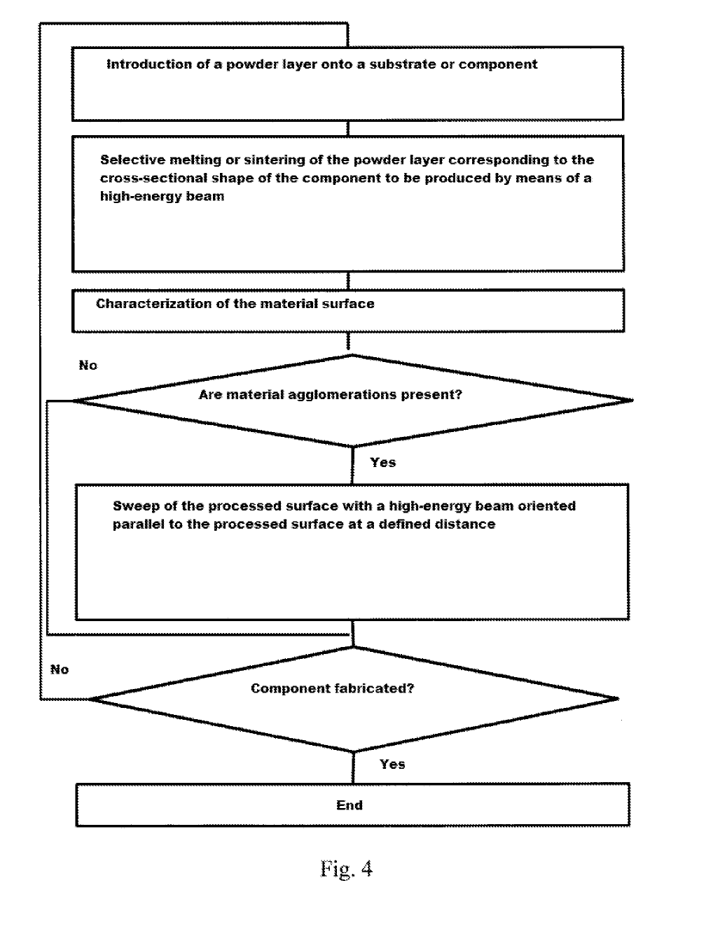

According to the variant that is shown in the flow chart of FIG. 4, after the step of material processing, a characterizing step is carried out, in which the material surface is investigated subsequently for whether material agglomerations are present, and optionally the shape of these agglomerations.

If it is established that relevant material agglomerations are present, in turn a high-energy beam aligned parallel to the processed surface is guided over the processed surface, in order to level off material agglomerations. If no relevant material agglomerations are determined in the characterizing step, the processing step of the sweep of the processed surface with a parallelly aligned, high-energy beam is omitted.

Although the present invention has been described in detail on the basis of exemplary embodiments, it is obvious to the person skilled in the art that the invention is not limited to these exemplary embodiments, but rather that modifications in form are possible, in that individual features are omitted or other types of combinations of features are realized, insofar as they do not leave the scope of protection of the appended claims. The present disclosure includes all combinations of all individual features presented.

What is claimed is:

1. A device for material processing with a high-energy beam (7), with a beam-generating device (4) for generating a high-energy beam and with a component holder (2), in which is disposed the material to be processed with the high-energy beam, wherein the beam-generating device and the component holder are disposed or can be disposed relative to one another so that the high-energy beam impinges on the material surface (12) of the material to be processed at an angle not equal to 0° or 180° or a whole-number multiple thereof, wherein the beam-generating device or at least parts thereof and/or another beam-generating device can be disposed, and/or that the beam-generating device comprises a deflection mechanism (5, 6), so that a high-energy beam (7a) can be aligned parallel to and at a distance from the material surface (12) to be processed.

2. The device according to claim 1, wherein the device has a processing plane in which the high-energy beam for material processing impinges on the material to be processed, wherein the processing plane is formed so that the high-energy beam can be guided parallel to and at a distance from the latter.

3. The device according to claim 1, wherein the component holder (2) has an uptake for a powder bed, in which powder can be taken up, and this powder can be bonded layerwise to at least one solid object by selective melting by means of the high-energy beam.

4. The device according to claim 1, wherein the deflection mechanism has at least one deflection mirror (6), which is adjustably mounted, in particular, movable along one or more axes and/or tiltable and/or rotatable around one or more axes.

5. The device according to claim 1, further comprising:
a beam absorber (14) at least partially surrounding the component holder and lying opposite a deflection mechanism for the high-energy beam.

6. The device according to claim 1, further comprising:
a means (17) for characterizing the surface that has been processed and/or that is to be processed.

7. A method for material processing with a high-energy beam (7), by a device (1) for material processing with a high-energy beam (7), with a beam-generating device (4) for generating a high-energy beam and with a component holder (2), in which is disposed the material to be processed with the high-energy beam, wherein the beam-generating device and the component holder are disposed or can be disposed relative to one another so that the high-energy beam impinges on the material surface (12) of the material to be processed at an angle not equal to 0° or 180° or a whole-number multiple thereof, wherein the beam-generating device or at least parts thereof and/or another beam-generating device can be disposed, and/or that the beam-generating device comprises a deflection mechanism (5, 6), so that a high-energy beam (7a) can be aligned parallel to and at a distance from the material surface (12) to be processed, in which the material to be processed is at least partially melted or sintered to a material surface (12) to be processed by means of the high-energy beam, wherein after melting the material, the beam or another high-energy beam (7a) is guided parallel to and at a distance from the material surface (12) to be processed, in order to eliminate or to reduce undesired agglomerations of material (16) found on the material surface (12).

8. The method according to claim 7, wherein the high-energy beam (7a) is guided at a distance of less than or equal to 200 μm, in particular less than or equal to 150 μm, preferably less than or equal to 100 μm over the processed material surface.

9. The method according to claim 7, wherein the high-energy beam (7a) is moved over the entire processed surface with guiding of the beam aligned parallel to the processed surface.

10. The method according to claim 7, wherein the material processing includes a layerwise manufacturing of a component from powder by means of selective laser-beam or electron-beam melting or sintering.

11. The method according to claim 7, wherein a sweep conducted with beam guidance parallel to the processed material surface is conducted after each layerwise, selective melting.

12. The method according to claim 7, wherein the processed material surface is characterized before and/or after and/or during a sweep with parallel beam guidance by means of microscope or interferometer methods by optical coherence tomography.

13. The method according to claim 12, wherein the sweep with parallel beam guidance is conducted as a function of the result of characterization.
